(19) United States
(12) Patent Application Publication
(10) Pub. No.: US 2004/0090337 A1
(43) Pub. Date: May 13, 2004

(54) Device for monitoring the operation of equipment

(76) Inventor: Kenneth Nordvik, Bergen (NO)

Correspondence Address: CARELLA, BYRNE, BAIN, GILFILLAN, CECCHI,, STEWART & OLSTEIN, 5 BECKER FARM ROAD, ROSELAND, NJ, 07068, US

(21) Appl. No.: 10/333,707

(22) PCT Filed: Jul. 25, 2001
(86) PCT No.: PCT/NO01/00320

(30) Foreign Application Priority Data
Jul. 25, 2000 (NO) 20003796

(51) Int. Cl. G08B 17/10

(52) U.S. Cl. 340/632; 340/693.6

(57) ABSTRACT

A device is described for warning of abnormal operating conditions such as development of gases, such as smoke fumes from smouldering in equipment such as electrical equipment and the like, or warning of gas leaks from containers, pipelines, etc., comprising a housing-forming element with inlets for rising air from the equipment, and a detector inside the housing for monitoring for the presence of any gases in the air from the equipment/container, and any increase in the temperature in the equipment. The device is characterised in that the housing defines one or more ducts, preferably in an upwardly direction, from the mentioned inlet and to the outlet from the housing, as each of the one or more ducts comprises a detector arranged in a duct, respectively. Also described is an application of the device.

The present invention relates to a device for monitoring the operating state of equipment, for example for warning of the development of gases, such as smoke fumes smouldering from overheating/fire in electrical equpment and the like, or warning of undesirable gas leaks from containers, pipelines, etc., comprising a housing-forming element with inlets for rising air from the equipment, and a detector inside the housing for monitoring for the existence of possible gases in the air from the equipment/container, and possible existing temperature increases of the equipment.

The invention relates in particular to the monitoring of the operating states and operating conditions of the equipment related to the risk for overheating/fire arising in such equipment. Consequently, the invention relates to a system for the monitoring of the condition of the equipment with respect to temperature, the rate at which a possible increase in temperature occurs, and the possible formation of gases other than air, i.e. smoke, in the equipment.

Consequently, the invention implies a new construction for a smoke detector.

Many fires today start in electrical equipment and installations. Normally, such small fires will start with an increase in temperature in the electrical system of the equipment, and then continue with the development of smoke and the development of a fire.

Today there are smoke alarms which are connected to alarm systems that can warn about such developments at an early stage. The well known systems for fire alarms in houses and industrial sites, comprises smoke and heat detectors which are placed in strategic positions around in the installation. The detectors can be connected in a network and connected up to a central alarm installation which manually or automatically is monitored from, for example, a control room, such as a guard central, the bridge of a ship, or the like.

Those equipment which often give rise to fires are as a rule electrical appliances, such as pc monitors/screens, TV sets, household equipment such as freezers, fridges, drum driers, hot water containers, electrical pumps, electricity generators, electrical motors and the like. Fire statistics show clearly that a large proportion of fires which originate in such equipment, or as a consequence of the misuse of such equipment, or origin from general faults in the electrical installation. It is known that equipment such as TV sets can comprise temperature and smoke detectors. These can, for example, lead to the power supply to the equipment being cut off if abnormal heat or smoke suddenly arises inside it. However, such detectors are not installed in a system with other equipment so that these are connected together in a safety network. The averting action is isolated to each individual equipment.

It is an aim of the invention to be able to carry out such a network connection, and such that a dangerous development in each individual equipment can be handled (notified of) at a much earlier stage than it has been possible hitherto. It is obvious that it is a great advantage that a small fire can be stopped while it is just starting inside the equipment itself, and not, for example, after the whole room is full of smoke or is in flames.

Furthermore, it is an aim of the invention that a user shall continuously be able to monitor the state of the equipment with respect to temperature, increases in temperature and formation of smoke fumes, to more quickly initiate actions such as warning of dangerous conditions, and at a much earlier stage than previously.

Consequently, it is an aim of the invention to provide a system which eliminates the disadvantages with the previously already known alarm systems.

Besides, it is an aim of the invention to provide a device which can be applied to the monitoring of gas leaks in general from containers, tanks, and pipelines. This is relevant within the chemical industry, oil refineries, and transport means (ships and the like) of hazardous chemicals.

It is a further aim of the invention to provide a new construction for a gas/smoke detector.

The device according to the invention is characterised by the features which arise from the characteristics given in the subsequent claim 1. Preferred embodiments of the device are defined in the claims 2-9. Applications of the device according to the invention are defined in the claims 10-14.

The object of the present invention is defined in the subsequent patent claims.

The additional advantages and aims of the invention will best be understood by referring to the subsequent description in connection with the enclosed figures, in which:

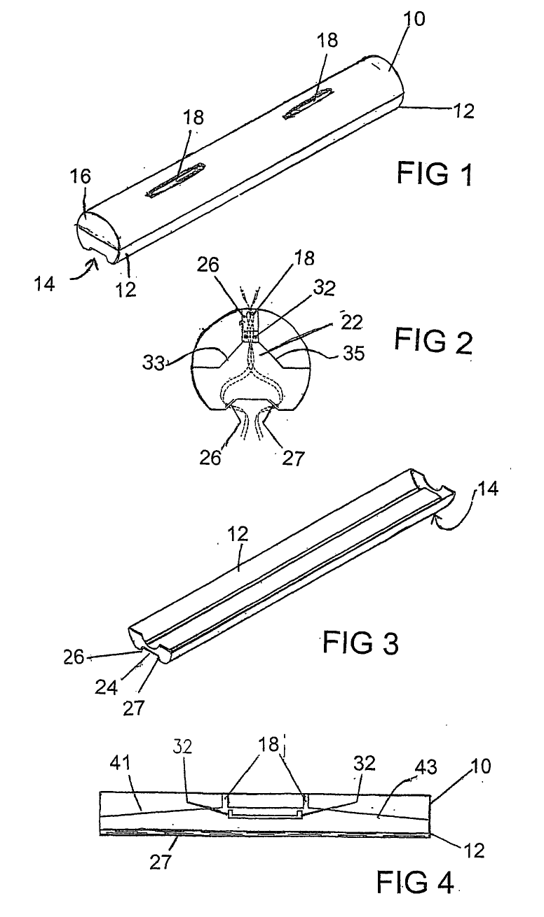

FIG. 1 shows a side view of a smoke detector according to the invention

FIG. 2 shows a cross section of the smoke detector according to the invention to show the flow-lines for smoke fumes which arise in an equipment.

FIG. 3 shows a side view of the lower part of the smoke detector according to the invention.

FIG. 4 shows a side section of the smoke detector according to the invention.

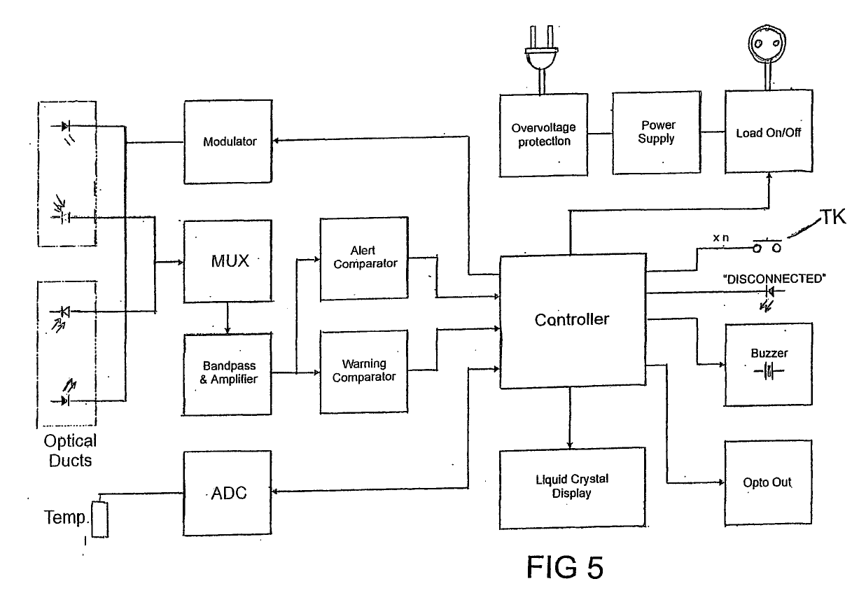

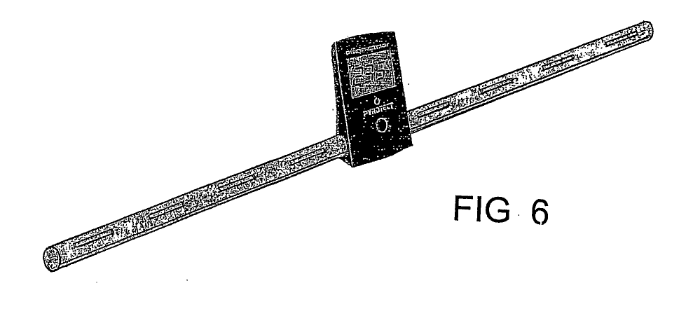

FIG. 5 shows a flow diagram for the connection of the detector units in the new smoke alarm construction, and its connection to the equipment which shall be made safe according to the invention.

Initially, reference shall be made to the FIGS. 1-3 which show different views of a preferred embodiment of a smoke detector according to the invention. The detector comprises an extended housing 10 which initially is a closed unit. The lower cover part 12 comprises inlet 14 for smoke fumes and the upper part 16 comprises outlet 18 for smoke fumes. Between the inlet 14 and outlet 18, the new smoke detector according to the invention forms a special duct-construction to lead the smoke fumes past a sensor element 20 which is placed inside the housing.

Additionally, the housing 10 itself has a shape up to the inlet 12 which is unique and new, and which promotes the catching and leading of smoke which rises upwards towards the housing, up to and in through the inlet to the hollow space 22 of the housing. This means that the smoke is partially concentrated or enriched in passing through the duct.

The inlet section of the housing 10 is constructed with a recess 24 which runs approximately in the whole of the longitudinal direction of the housing. In both sides of the sidewall of the recess, there are shaped ribs which form the inlet openings 26,27 to the hollow space.

Preferably, these openings also run the whole of the longitudinal length of the housing 10. Inside the housing, in the upper section running along its longitudinal direction, a number of upwardly extending outlet ducts 30 (preferably 3 outlets for a detector length of 50 cm) are formed. The ducts run upwards towards the outlet 18. As the outlets 26,18 result in a narrowing of the flow cross-section area with respect to the inlets, this means that any possible smoke fumes will be enriched in the outlet duct. The detector 30 itself (see FIG. 3) is placed in this duct. Furthermore, the recessed bottom section with the laterally placed inlet ducts of the housing, will result in a better catching of any smoke which simply cannot <<get away>> with the new shape of the detector according to the invention.

Thus, the new smoke detector has an extended shape which makes it particularly suited to cover a wide area in the horizontal plane. The unit is meant to be placed above the ventilation slots on the equipment in question (as mentioned above). The detector has an extended rod or sheath form, and comprises a securing body such that the detector can be rotated up to 90° (degrees). In addition, the detector has small dimensions in the height and width directions, so that it does not require much space and can thereby easily be placed above the ventilation slots of the apparatus. Its unique shape makes the unit especially suited to detect small fires in selected areas, so-called spot-detection.

It is described above that a sensor 32 is arranged in each outlet duct. This means that the sensor 32 is placed uppermost in the duct in the area where the outlet slot 18 itself in the outer cover starts. Each sensor 32 is made up of an infrared transmitter which emits a modulated IR-light, for example across the flow direction of the smoke fumes. When smoke fumes flow up into the chamber the light will be reflected and this is picked up by a detector which is also placed in the sensor. The extent of reflected light indicates the density of smoke in the chamber.

Preferably, automatic controls are built in which adjust the sensitivity of the sensors when they gradually become dirty, for example by cooking fumes (fat), dust and the like. This means that a gradual fouling will not lead to a triggering of the alarm, but when such fouling reaches a given level (such as thickness of the dirt layer) the unit will indicate optically and/or acoustically when the optics must be cleaned.

A flow diagram is given in FIG. 4 as a non-limiting example of both the elements the sensor is comprised of and how these are connected and function.

The sensors in the described alarm unit is operated functionally, i.e. by transmission of a signal (infrared light) and reception of reflected signal, by way of a central unit in the shape of a controller which supplies status signals to a display unit, possibly to other alarms (Opto Out), buzzer for acoustic warning, diodes for status reporting, a mains switch to the connected apparatus (converts net voltage to the operating voltage of the unit), and an overvoltage protection connected to the plug itself. The overvoltage protection device guards the unit and the associated apparatus for overvoltages and transients caused by lightening or other equipment. Furthermore, the controller is connected to a panel in the equipment in question with the necessary keyboard buttons to operate and calibrate the unit. In addition, a separate temperature sensor can be connected to the controller by way of an ADC which converts the analogue temperature reading to a digital format.

The controller controls the emission of the infrared light from the smoke detector according to FIG. 1, by way of a modulator which modulates the infrared light to a desired frequency for transmission. In this example there are two such modulators as the smoke detector comprises two sensor units.

Any received signal from the sensor is sent back to the controller by way of an amplifying unit and band pass filter unit and an alarm comparator. In these elements the signals are amplified and undesirable noise filtered away, respectively.

The sensor reading is fed into a filter which will only let through infrared light in the desired frequency band. The signals are thereafter processed and amplified and fed to a comparator step which generates an optical and/or acoustic signal of smoke detection above a set limiting value. With a detection of an amount of smoke above a set limiting value, the unit will disconnect any connected equipment and notify of this optically and/or acoustically. Connected equipment is connected up again manually by pressing the relevant keyboard keys.

An alternative solution is shown in FIG. 5, in which the detector construction according to the invention comprises a temperature sensor comprising a display which shows actual temperature in the area inside the detector. With this solution, the user can have a general view of the temperature in the equipment at all times. Normally there are no temperature changes, but if something happens in the electrical circuit of the equipment, this will be shown on the display and the user will get an early warning of this. The unit removes the operating voltage as soon as a possible small fire is detected.

By modulating the infrared light one eliminates the influence of daylight and other IR light sources and the chambers do not need therefore to be closed to the same extent as in traditional optical smoke alarms.

The unit can be equipped with a pulse outlet which makes it possible to be connected to a so-called LON network. It can also be connected directly to existing alarms. This works so that the units in the different electrical equipment which, for example, are found in a home, can be coupled together in a network, and the control of the network can occur by way of a computer. If this computer is connected to the internet, the condition in each of all electrical equipment which exist in a house be monitored remotely, for example, when the user is on travel. For example, the electricity meter, such as in a housing cooperative, can be read remotely. Messages about the conditions in the electrical equipment can be distributed to a guard/alarm central or directly to a mobile phone in the form of a SMS message.

This system which can control the condition inside electrical equipment, can also be used to monitor general operating conditions in the connected equipment. This can, for example, be conditions such as overvoltages or undervoltages in the electricity net, earth failures or other conditions which can influence a secure operation. A central unit which monitors general operating conditions will be a cost effective way to secure more parameters.

1. Device for monitoring the operational conditions in equipment, for example, for warning of development of gases, such as smoke fumes smouldering from overheating/ fire in electrical equipment and the like, or warning of undesirable gas leaks from containers, pipelines, etc., comprising a housing-forming element with inlets for rising air from the equipment, and a detector inside the housing for monitoring of the presence of any gases in the air from the equipment/container, and the presence of any temperature increases in the equipment, characterised in that the housing defines one or more ducts or chambers, preferably in an upwardly direction, from the mentioned inlet and to the outlets from the housing, with each of the one or more ducts/chambers comprising one detector respectively.

2. Device according to claim 1, characterised in that the duct(s) defines/define a through-flow duct for air/gas.

3. Device according to claims 1-2, characterised in that the duct comprises a narrowing of the flow cross-section, said narrowing leads to an enrichment of any gases present which rise upwards and through the inlet of the device.

4. Device according to claim 3, characterised in that the detector(s) is/are arranged in the mentioned narrowing of the flow cross-section.

5. Device according to one of the preceding claims, characterised in that the detector comprises an infrared sensor which is set up to emit a modulated IR-light, for example, across the direction of flow of the smoke fumes, and when smoke flows up in the chamber, the light is reflected, and that the detector comprises a sensor, where the extent of reflected light indicates the density of smoke in the chamber.

6. Device according to one of the preceding claims, characterised in that the detector is coupled to the electricity supply for the equipment in a manner known per se, and arranged to disconnect this at registration of smoke or temperature above a set limiting value.

7. Device according to one of the preceding claims, characterised in that the detector comprises a temperature sensor in a manner known per se, and the device comprises a display which indicates the actual temperature of the through-flowing air/smoke fume.

8. Device according to one of the preceding claims, characterised in that it has the shape of an elongated housing, the underside of which is shaped with a recess which runs by and mainly along the whole of the longitudinal direction of the housing, with rib-formed inlet openings to the duct through the house formed on both of the sidewalls of the recess.

9. Device according to one of the preceding claims, characterised in that the sensitivity of the sensors is arranged to be adjusted as they gradually become covered by dirt, for example, such as cooking fumes (fat), dust and the like.

10. Use of the device according to claims 1-8, in association with fireproofing of electrical appliances such as pc-monitors/screens, TV sets, household equipment such as freezers, fridges, washing machines, drum driers, hot-water containers, electrical pumps, electricity generators, electrical motors, and the like.

11. Application according to claim 9, with each of the possible appliances mentioned above being fitted with a device according to claims 1-8, with these being coupled together in a network, and the control of each individual appliance in the network can occur by way of a computer.

12. Application according to claim 10, with the computer being connected to the internet, whereby the condition in each individual appliance (electrical equipment) can be monitored remotely, for example, when a user is on holiday.

13. Application according to claims 10 and 11 for control of conditions in the electrical equipment by distribution to a guard/alarm central or directly to a mobile phone in the form of an SMS message.

14. Application of the device according to claims 1-8, for the warning of undesired gas leaks from containers, pipelines, etc., within the chemical industry, oil refineries, and transport means (ships and the like) for hazardous chemicals.
